(19) United States
(12) Patent Application Publication
(10) Pub. No.: US 2005/0033680 A1
(43) Pub. Date: Feb. 10, 2005

(54) Technique relating to commodity trading management device

(75) Inventor: Yasuo Shibusawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/864,893

(22) Filed: Jun. 10, 2004

(30) Foreign Application Priority Data
Jun. 13, 2003 (JP) 2003-169840

(51) Int. Cl. G06F 17/60

(52) U.S. Cl. 705/37

(57) ABSTRACT

The technique of the invention authenticates a user of a client terminal, which has sent request data of requiring execution of a discount service setting process, on a user authentication window (steps S100 and S110). In the case of an authorized user, the technique retrieves a user class corresponding to an entered user ID in a user table (step S120), sets discount service-relating data (including commodity IDs and a discount rate) based on the retrieved user class (step S130), and writes the settings of the discount service-relating data into cookie files in the client terminal (step S140).

### BACKGROUND OF THE INVENTION

1. Field of the Invention

The present invention relates to a commodity trading management device, a storage medium in which a program used for the commodity trading management device is stored, as well as a service-providing data generation device, a commodity trading publicity device, and a commodity trading management system.

2. Description of the Prior Art

A proposed technique relating to the commodity trading management device displays a lineup of ‘bargains’ on an online shopping site provided by a server located on the Internet (see, for example, Japanese Patent Laid-open Application No.2001-351006). This method prepares a Web page, which is equivalent to an insert showing the lineup of ‘bargains’, and displays the Web page as a top page on the online shopping site or in response to a click of a predetermined button.

### SUMMARY OF THE INVENTION

The prior art technique relating to the commodity trading management device commonly shows the same Web page, which is equivalent to the insert, to all the customers. There are accordingly difficulties in providing adequate services to different customer segments, for example, in introducing different commodities to different customer segments. A simple countermeasure against this problem prepares different Web pages for different customer segments. This method, however, requires preparation of a number of different Web pages corresponding to the number of different customer segments and timely updating of these Web pages. This undesirably complicates the system configuration and increases the cost of system construction and maintenance.

The commodity trading management device, the service-providing data generation device, the commodity trading publicity device, and the commodity trading management system of the invention thus aim to provide diverse services to various users in online commodity trading. The commodity trading management device, the service-providing data generation device, the commodity trading publicity device, and the commodity trading management system of the invention also aim to easily actualize the mechanism of providing adequate services to the respective users in online commodity trading.

In order to attain at least part of the above aims, the present invention is constructed as follows.

The present invention is directed to a commodity trading management device that manages information on trading of commodities with multiple client devices connected via a communication line, the commodity trading management device including: a data storage module that stores at least commodity data relating to commodities; a data reception transmission module that receives and transmits data from and to each of the multiple client devices; a service-providing data generation module that causes the data reception transmission module to receive application data for a preset additional service relating to trading of a commodity sent from one of the multiple client devices and generates service-providing data required to receive the preset additional service based on the received application data; a service-providing data transmission module that causes the data reception transmission module to send the generated service-providing data to the client device in a storable manner; and a trading process execution module that, in the case of storage of the service-providing data in the client device that establishes connection with the commodity trading management device via the communication line, causes the data reception transmission module to receive the service-providing data from the client device and executes a commodity trading process for the preset additional service based on the received service-providing data and the commodity data stored in the data storage module, the trading process execution module executing a standard commodity trading process based on the commodity data stored in the data storage module in the case of no storage of the service-providing data in the client device.

The commodity trading management device of the invention generates service-providing data required to receive a preset additional service in response to an application for the preset additional service from a client device, and sends the generated service-providing data to the client device. In the case of storage of the service-providing data in the client device that establishes connection with the commodity trading management device via a communication line, the commodity trading management device executes a commodity trading process for the preset additional service, based on the service-providing data. In the case of no storage of the service-providing data in the client device, on the other hand, the commodity trading management device executes a standard commodity trading process. Namely, the device generates the service-providing data in response to an application for the preset additional service, sends the generated service-providing data to the client device, and executes the commodity trading process for the preset additional service based on the transmitted service-providing data. The commodity trading management device generates the service-providing data according to the application data from the client device and executes the commodity trading process for the preset additional service according to the application data from the client device, based on the generated service-providing data. This arrangement enables different services to be provided to the respective client devices. Here the terminology ‘commodity trading process’ includes diverse processes relating to trading of commodities with multiple client devices connected via a communication line, for example, a process of sending window data of a display window to display commodity-relating information to each of the client devices and a process of calculating a sum total of selected commodities in an order in response to an instruction from each of the client devices. The commodity trading management device of the invention may be actualized as a computer system including multiple computers.

In one preferable embodiment of the invention, the commodity trading management device functions as a Web server. In case of a Web server, the service-providing data transmission module may send the service-providing data as data of at least part of cookie files stored in the client device. In another preferable embodiment of the commodity trading management device of the invention, the service-providing data generation module regards access request data for an access to a preset resource sent from the client device as the application data and generates the service-providing data based on the access request data regarded as the application data. in another preferable embodiment of the commodity trading management device of the invention, the service-providing data generation module executes a predetermined user authentication process to determine whether a user of the client device that has sent the application data is an authorized user or an unauthorized user, and generates the service-providing data when it is determined that the user of the client device is an authorized user.

In another preferable embodiment of the commodity trading management device of the invention, the data storage module stores at least user identification information on identification of each user and user class information regarding a class of the user, as user-relating information, and the application data include user identification information on a user of the client device that has sent the application data. In this case, the service-providing data generation module reads the user identification information of the application data, retrieves the user class information corresponding to the user identification information stored in the data storage module, and generates the service-providing data based on the retrieved user class information. In another embodiment of the commodity trading management device of the embodiment, the data storage module stores at least user identification information on identification of each user and a data generation frequency, which represents a frequency of generation of the service-providing data with regard to the user, as user-relating information, and the application data include user identification information on a user of the client device that has sent the application data. In this case, the service-providing data generation module reads the user identification information of the application data, retrieves the data generation frequency corresponding to the user identification information stored in the data storage module, and generates the service-providing data and updates the data generation frequency stored in the data storage module when the retrieved data generation frequency is within a present number of times.

In another preferable embodiment of the commodity trading management device of the invention, the service-providing data transmission module sends the service-providing data to the client device, while sending instruction data for connection to the commodity trading management device to the client device. In still another preferable embodiment, the service-providing data include at least a valid term of the preset additional service, and the trading process execution module determines, in the case of storage of the service-providing data in the client device, whether a current time is within the valid term based on the valid term of the service-providing data, and executes the commodity trading process for the preset additional service in the case of determination that the current time is within the valid term, while executing the standard commodity trading process in the case of determination that the current time is out of the valid term.

In still another preferable embodiment of the commodity trading management device of the invention, the preset additional service is a discount service of a commodity. In this case, the commodity data include at least a standard price of the commodity, and the commodity trading process for the preset additional service makes a discount on the standard price of the commodity. As one application of the above embodiment, the service-providing data include subject commodity identification information on identification of a subject commodity of the discount service, and the commodity trading process for the preset additional service makes a discount on the standard price of the subject commodity specified by the subject commodity identification information. As another application of the above embodiment, the service-providing data include discount rate information on a discount rate of the discount service, and the commodity trading process for the preset additional service makes a discount on the standard price of the commodity according to the discount rate information.

In one preferable embodiment of the commodity trading management device of the invention, the preset additional service may be a commodity upgrade service. In case of a commodity upgrade service, the commodity trading process for the preset additional service upgrades the commodity at an identical price. In another preferable embodiment, the preset additional service may be an exclusive commodity providing service. In case of an exclusive commodity providing service, the commodity data include at least exclusive commodity class information on a class of exclusive commodity, and the commodity trading process for the preset additional service enables trading of an exclusive commodity specified by the exclusive commodity class information. In another preferable embodiment of the invention, the service-providing data include subject commodity identification information on identification of a subject commodity of the exclusive commodity providing service, and the commodity trading process for the preset additional service enables trading of an exclusive commodity specified by the subject commodity identification information.

The present invention is also directed to a storage medium in which a commodity trading management device program is stored, the commodity trading management device program causing a computer, which includes a data storage module that stores at least commodity data relating to commodities and a data reception transmission module that receives and transmits data from and to each of multiple client devices, to function as a commodity trading management device that manages information on trading of commodities with the multiple client devices connected via a communication line, the commodity trading management device program stored in the storage medium including: a service-providing data generation module that causes the data reception transmission module to receive application data for a preset additional service relating to trading of a commodity sent from one of the multiple client devices and generates service-providing data required to receive the preset additional service based on the received application data; a service-providing data transmission module that causes the data reception transmission module to send the generated service-providing data to the client device in a storable manner; and a trading process execution module that, in the case of storage of the service-providing data in the client device that establishes connection with the commodity trading management device via the communication line, causes the data reception transmission module to receive the service-providing data from the client device and executes a commodity trading process for the preset additional service based on the received service-providing data and the commodity data stored in the data storage module, the trading process execution module executing a standard commodity trading process based on the commodity data stored in the data storage module in the case of no storage of the service-providing data in the client device.

The storage medium of the invention stores a program, which causes the computer to function as the commodity trading management device. The commodity trading management device generates service-providing data required to receive a preset additional service in response to an application for the preset additional service from a client device, and sends the generated service-providing data to the client device. In the case of storage of the service-providing data in the client device that establishes connection with the commodity trading management device via a communication line, the commodity trading management device executes a commodity trading process for the preset additional service, based on the service-providing data. In the case of no storage of the service-providing data in the client device, on the other hand, the commodity trading management device executes a standard commodity trading process. Installation of this program in the computer causes the computer to generate the service-providing data in response to an application for the preset additional service, to send the generated service-providing data to the client device, and to execute the commodity trading process for the preset additional service based on the transmitted service-providing data. The program stored in the storage medium includes the modules to function the computer as the commodity trading management device, which generates the service-providing data according to the application data from the client device and executes the commodity trading process for the preset additional service based on the generated service-providing data. Installation of this program in the computer causes the computer to execute the commodity trading process for the preset additional service according to the application data from the client device. This arrangement enables different services to be provided to the respective client devices. Here the terminology ‘commodity trading process’ includes diverse processes relating to trading of commodities with multiple client devices connected via a communication line, for example, a process of sending window data of a display window to display commodity-relating information to each of the client devices and a process of calculating a sum total of selected commodities in an order in response to an instruction from each of the client devices. The commodity trading management device program stored in the storage medium of the invention may cause a computer system including multiple computers to function as the commodity trading management device.

The present invention is also directed to a service-providing data generation device that generates service-providing data required to receive a preset additional service relating to trading of commodities with multiple client devices connected via a communication line, the service-providing data generation device including: a data reception transmission module that receives and transmits data from and to each of the multiple client devices; a service-providing data generation module that causes the data reception transmission module to receive application data for the preset additional service relating to trading of a commodity sent from one of the multiple client devices and generates the service-providing data based on the received application data; and a service-providing data transmission module that causes the data reception transmission module to send the generated service-providing data to the client device in a storable manner.

The service-providing data generation device of the invention generates the service-providing data required to receive the preset additional service in response to an application for the preset additional service from the client device and sends the generated service-providing data to the client device. This arrangement enables various devices that provide the preset additional service to utilize the service-providing data.

In one preferable embodiment of the invention, the service-providing data generation device functions as a Web server. In case of a Web server, the service-providing data transmission module sends the service-providing data as data of at least part of cookie files stored in the client device.

The present invention is further directed to a commodity trading publicity device that publicizes trading of commodities by a commodity trading management device, the commodity trading management device receiving application data for a preset additional service relating to trading of a commodity sent from one of multiple client devices connected via a communication line, generating service-providing data required to receive the preset additional service based on the received application data, sending the generated service-providing data to the client device, and executing, in the case of storage of the service-providing data in the client device that establishes connection with the commodity trading management device via the communication line, a commodity trading process for the preset additional service based on the service-providing data, while executing a standard commodity trading process in the case of no storage of the service-providing data in the client device, the commodity trading publicity device including: a data storage module that has a transmission instruction area to instruct the client device to send the application data to the commodity trading management device and stores data regarding a predetermined electronic medium to publicize trading of commodities by the commodity trading management device; and an electronic medium output module that outputs the predetermined electronic medium to the client device, based on the data regarding the predetermined electronic medium stored in the data storage module.

The commodity trading publicity device of the invention outputs the predetermined electronic medium to the client device. Here the predetermined electronic medium includes the transmission instruction area, which instructs the client device to send the application data for the preset additional service to the commodity trading management device. The predetermined electronic medium publicizes and advertises trading of commodities by the commodity trading management device and encourages the user of the client device to send the application data for the preset additional service.

In one preferable embodiment of the commodity trading publicity device of the invention, the predetermined electronic medium may be a Web page or an e-mail. In this case, the transmission instruction area represents an area of instructing the client device to send the application data by means of a hyperlink function.

The present invention is further directed to a commodity trading management system that includes a commodity trading management device that manages information on trading of commodities with multiple client devices connected via a communication line and a commodity trading publicity device that publicizes trading of commodities by the commodity trading management device, the commodity trading management device including: a data storage module that stores at least commodity data relating to commodities; a data reception transmission module that receives and transmits data from and to each of the multiple client devices; a service-providing data generation module that causes the data reception transmission module to receive application data for a preset additional service relating to trading of a commodity sent from one of the multiple client devices and generates service-providing data required to receive the preset additional service based on the received application data; a service-providing data transmission module that causes the data reception transmission module to send the generated service-providing data to the client device in a storable manner; and a trading process execution module that, in the case of storage of the service-providing data in the client device that establishes connection with the commodity trading management device via the communication line, causes the data reception transmission module to receive the service-providing data from the client device and executes a commodity trading process for the preset additional service based on the received service-providing data and the commodity data stored in the data storage module, the trading process execution module executing a standard commodity trading process based on the commodity data stored in the data storage module in the case of no storage of the service-providing data in the client device, the commodity trading publicity device including: a data storage module that has a transmission instruction area to instruct the client device to send the application data to the commodity trading management device and stores data regarding a predetermined electronic medium to publicize trading of commodities by the commodity trading management device; and an electronic medium output module that outputs the predetermined electronic medium to the client device, based on the data regarding the predetermined electronic medium stored in the data storage module.

In the commodity trading management system of the invention, the commodity trading publicity device of the invention outputs the predetermined electronic medium to the client device. Here the predetermined electronic medium includes the transmission instruction area to instruct the client device to send the application data for the preset additional service to the commodity trading management device. The commodity trading management device generates the service-providing data required to receive the preset additional service in response to an application for the preset additional service from the client device and sends the generated service-providing data to the client device. In the case of storage of the service-providing data in the client device that establishes connection with the commodity trading management device via the communication line, the commodity trading management device executes the commodity trading process for the preset additional service, based on the service-providing data. In the case of no storage of the service-providing data in the client device, on the other hand, the commodity trading management device executes the standard commodity trading process. In the commodity trading management system of the invention, the predetermined electronic medium output by the commodity trading publicity device publicizes and advertises trading of commodities by the commodity trading management device and encourages the user of the client device to send the application data for the preset additional service. In response to an application for the preset additional service, the commodity trading management device generates and sends the service-providing data to the client device, and executes the commodity trading process for the preset additional service based on the service-providing data.

### BRIEF DESCRIPTION OF THE DRAWINGS

FIG. 1 schematically illustrates the configuration of a commodity trading management system 10;

FIG. 2 shows one example of information managed in a commodity table 29a;

FIG. 3 shows one example of information managed in a user table 29b;

FIG. 4 shows one example of a top page 60 of a portal site;

FIG. 5 is a flowchart showing a discount service setting routine;

FIG. 6 shows one example of a user authentication window;

FIG. 7 shows a map of the settings of discount service-relating data to a user class;

FIG. 8 is a flowchart showing a commodity trading routine;

FIG. 9 shows one example of a commodity display window 70;

FIG. 10 shows one example of a discount service information popup window 72;

FIG. 11 shows one example of an ordered commodity check window 80; and

FIG. 12 shows one example of the checkout process window 90.

### DESCRIPTION OF THE PREFERRED EMBODIMENTS

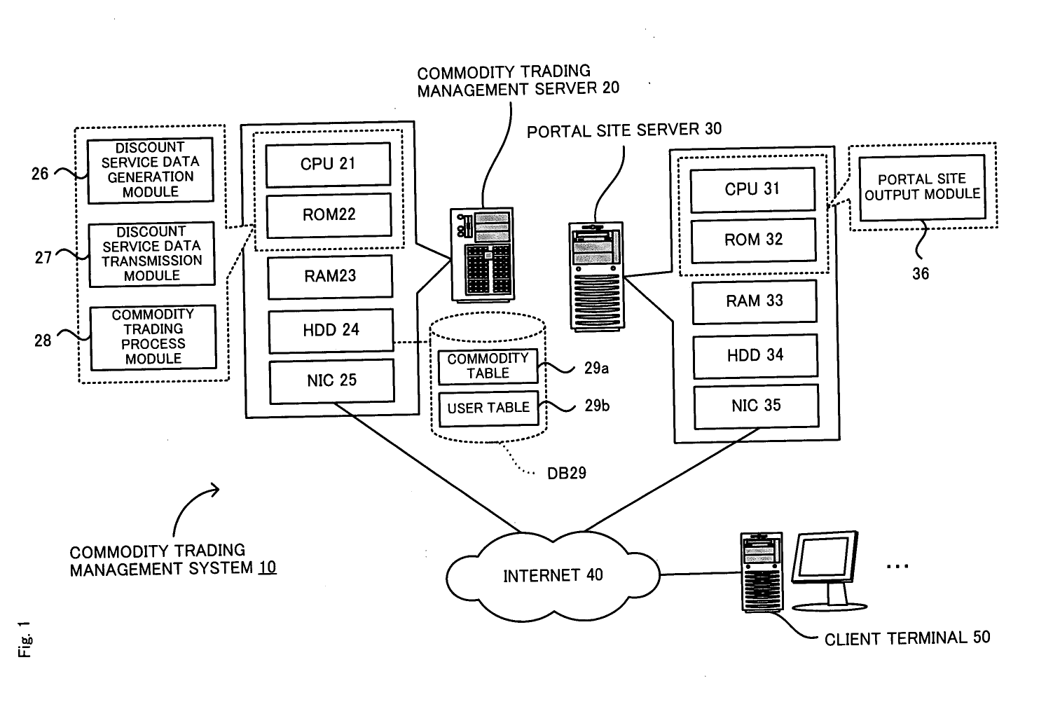

One preferred embodiment of the invention is discussed below. FIG. 1 schematically illustrates the configuration of a commodity trading management system 10 that includes a commodity trading management server 20 functioning as one embodiment of the commodity trading management device of the invention and a portal site server 30 functioning as one embodiment of the commodity trading publicity device of the invention. As illustrated, the commodity trading management system 10 includes the commodity trading management server 20, the portal site server 30, and client terminals 50, which are mutually connected via the Internet 40.

As illustrated, the commodity trading management server 20 of the embodiment is constructed as a general-purpose computer including a CPU 21, a ROM 22, and a RAM 23 and additionally has a hard disk drive (HDD) 24 for storing a diversity of data and a network interface card (NIC) 25 for connection to a network. The commodity trading management server 20 functions as a Web server that sends Web pages in response to a request from a client terminal 50, and provides a commodity trading site to the client terminal 50. The HDD 24 stores HTML files and image files, which are used to construct Web pages on the commodity trading site, and diverse programs. A database 29 as a general DBMS (database management system) is installed in the HDD 24. The database 29 includes a commodity table 29a for management of commodity-relating information and a user table 29b for management of use-relating information. The commodity trading management server 20 includes a discount service data generation module 26 that generates discount service-relating data in response to a request from each of the client terminals 50, a discount service data transmission module 27 that sends the generated discount service-relating data to the corresponding client terminal 50, and a commodity trading process module 28 that executes diverse series of processing relating to trading of commodities. The commodity trading management server 20 activates these modules to execute a discount service setting routine and a commodity trading routine discussed later. The discount service data generation module 26, the discount service data transmission module 27, and the commodity trading process module 28 shown as functional blocks in FIG. 1 are actualized by the combined functions of the CPU 21, the ROM 22, and the diverse programs stored in the HDD 24.

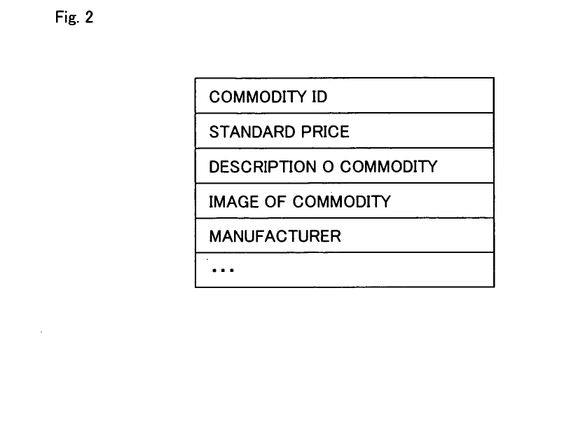

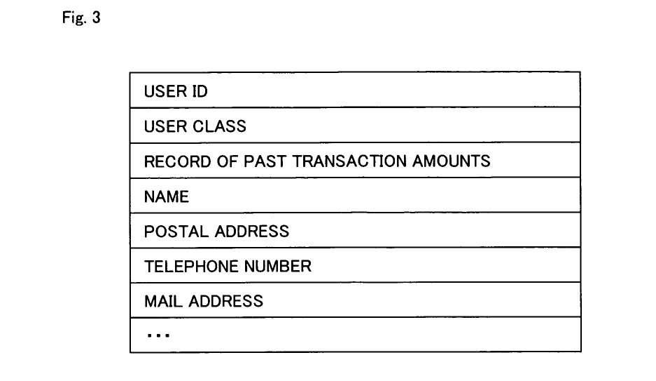

FIG. 2 shows one example of the information managed in the commodity table 29a of the database 29. FIG. 3 shows one example of the information managed in the user table 29b of the database 29. The commodity table 29a is designed to manage information including an ID for identifying each commodity (commodity ID), as well as the standard price, the description, the image data, and the manufacturer of the commodity, as shown in FIG. 2. The user table 29b is designed to manage information including an ID for identifying each user (user ID), a user class (class of the user), a record of past transaction amounts by the user, and the name, the postal address, the telephone number, and the mail address of the user, as shown in FIG. 3. The structure of the embodiment classifies each user based on the record of past transaction amounts and sets the user class in the user table 29b for the purpose of management. This is, however, not restrictive at all, and the user may be classified on another basis.

As shown in FIG. 1, the portal site server 30 of the embodiment is constructed as a general-purpose computer including a CPU 31, a ROM 32, and a RAM 33 and additionally has a hard disk drive (HDD) 34 for storing a diversity of data and a network interface card (NIC) 35 for connection to the network. The portal site server 30 functions as a Web server that sends Web pages in response to a request from each of the client terminals 50, and provides a portal site to the client terminal 50. The HDD 34 stores HTML files and image files, which are used to construct Web pages on the portal site, and diverse programs. The portal site server 30 has a portal site output module 36 that sends the Web pages of the portal site. The portal site output module 36 shown as a functional block in FIG. 1 is actualized by the combined functions of the CPU 31, the ROM 32, and the diverse programs stored in the HDD 34.

The client terminal 50 is constructed as a general-purpose computer including a CPU, memories, and a hard disk drive (not shown), and a Web browser is installed in the client terminal 50 to display Web pages. Multiple client terminals 50 and other client devices having equivalent functions to those of the client terminals 50 (for example, cell phones, personal digital assistants, and home video game machines) may be connected to the Internet 40.

The following describes the operations of the commodity trading management system 10 constructed as discussed above. The description sequentially regards a series of operations relating to transmission of a Web page on the portal site provided by the portal site server 30, a series of processing relating to the settings of a discount service (discount service setting process), and a series of processing relating to trading of commodities (commodity trading process) on a commodity trading site executed by the commodity trading management server 20.

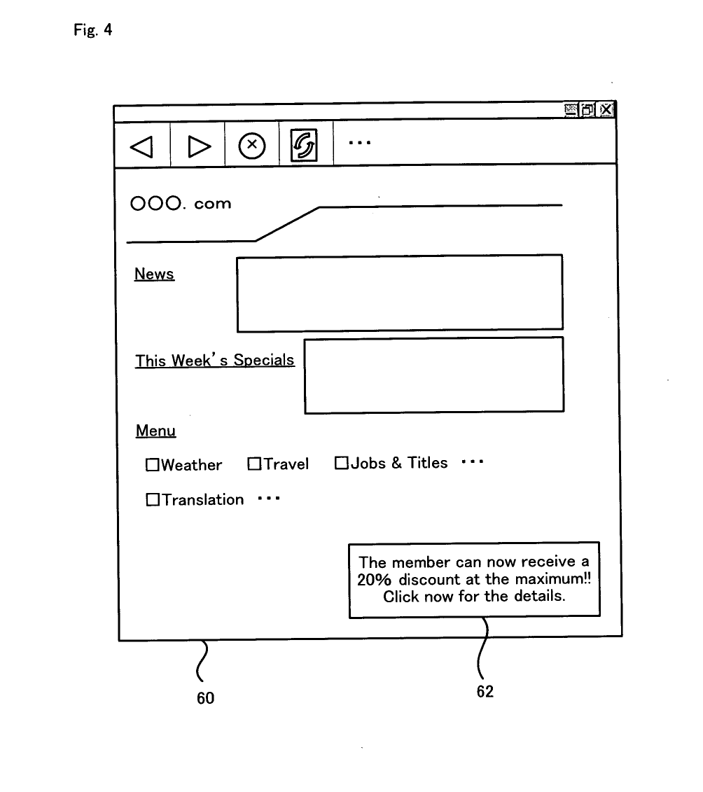

In response to transmission of request data to request delivery of a Web page from the client terminal 50, the portal site server 30 of the embodiment sends image data of a top page 60 shown in FIG. 4 to the client terminal 50. As shown in FIG. 4, the top page 60 sent by the portal site server 30 is designed as a typical portal site top page showing a list of information including the news of the day and the weather. The top page 60 also includes a banner ad 62 to advertise and publicize trading of commodities by the commodity trading management server 20 of the embodiment. In the illustrated example, the banner ad 62 is a message telling that ‘the member can now receive a 20% discount at the maximum’ as the information on advertisement and publicity of trading of commodities by the commodity trading management server 20. In response to the user's click of this banner ad 62, the portal site server 30 causes request data for requiring execution of the discount service setting process to be sent from the client terminal 50 to the commodity trading management server 20. In the structure of this embodiment, a hyperlink to a file (for example, an HTML file or an ASP file) stored on the commodity trading management server 20, which executes the discount service setting process, is set on the banner ad 62.

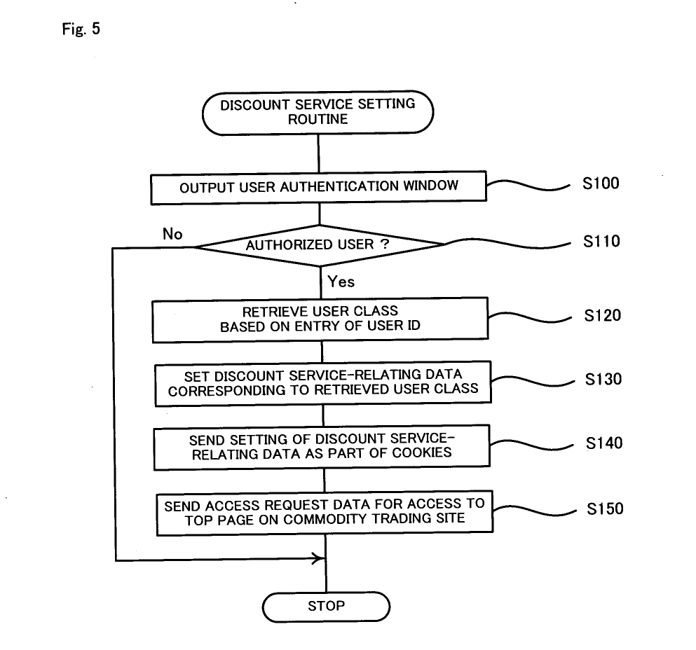

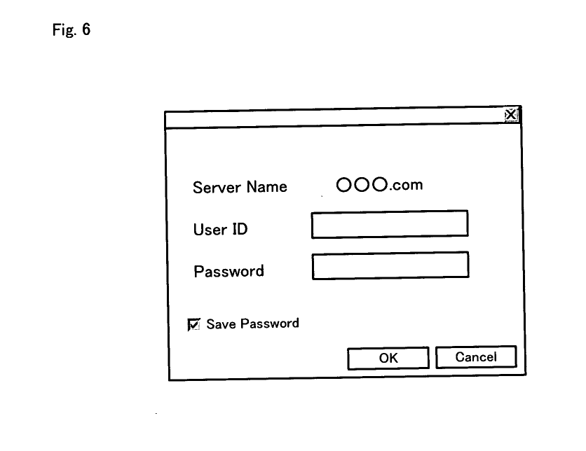

The description now regards the discount service setting process executed by the commodity trading management server 20 of the embodiment. The discount service setting process is executed, when the request data for requiring execution of the discount service setting process is sent from the client terminal 50 to the commodity trading management server 20 in response to the user's click of the banner ad 62 on the top page 60 provided by the portal site server 30. FIG. 5 is a flowchart showing a discount service setting routine. The discount service setting routine first outputs image data of a user authentication window to the client terminal 50 (step S100). FIG. 6 shows one example of the user authentication window. The user authentication window asks the user of the client terminal 50 to enter a user ID and a password for the purpose of authentication of the user. Authentication of the user may utilize the standard functions of a Web server or execute a CGI program. The discount service setting routine determines whether the user of the client terminal 50 is an authorized user or an unauthorized user via the user authentication window output to the client terminal 50 (step S110). In the case of an unauthorized user, the discount service setting routine skips all the subsequent steps and is immediately terminated.

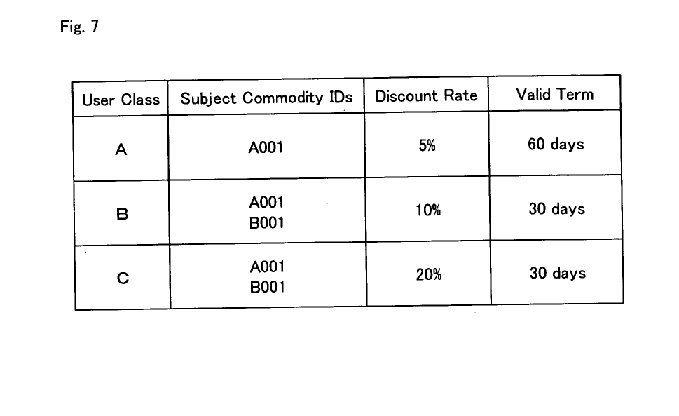

In the case of an authorized user, the routine retrieves the user table 29a in the database 29 and refers to the value of the user class corresponding to the user ID entered on the user authentication window (step S120), and sets discount service-relating data based on the value of the user class (step S130). In this embodiment, the discount service-relating data include, for example, a commodity ID allocated to each commodity as a subject of a discount service, a discount rate and a valid term of the discount service. The settings of the discount service-relating data are related to each user class and are stored in advance in the database 29. FIG. 7 shows a map of the settings of the discount service-relating data to the user class. In the map of this illustrated example, different settings of the discount service-relating data are given to the respective user classes A, B, and C. The procedure of this embodiment classifies each user according to the record of past transaction amounts as mentioned previously. The subject commodities, the discount rate, and the valid term of the discount service are thus set according to the record of past transaction amounts.

After setting the discount service-relating data, the routine writes the discount service-relating data into cookie files stored in the client terminal 50 (step S140) . Here the cookie files are text files generally used for transmission of information between a Web server and a Web browser, and are stored in a predetermined folder in the client terminal 50, where the Web browser is installed. The routine subsequently sends data for an access to a top page on a commodity trading site provided by the commodity trading management server 20 to the client terminal 50 (step S150). The discount service setting routine is then terminated.

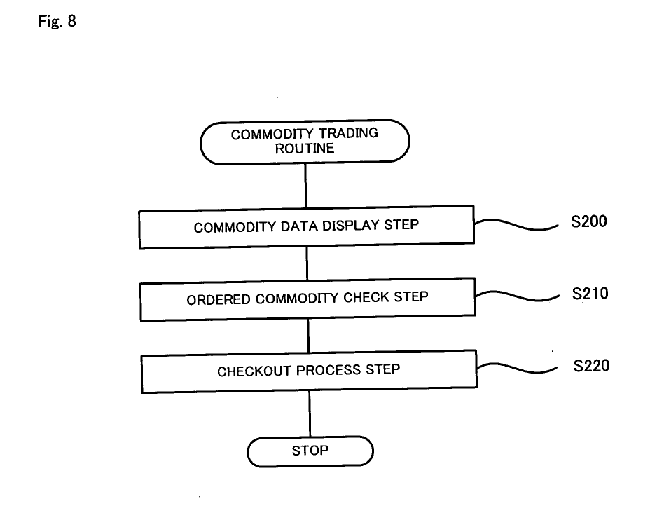

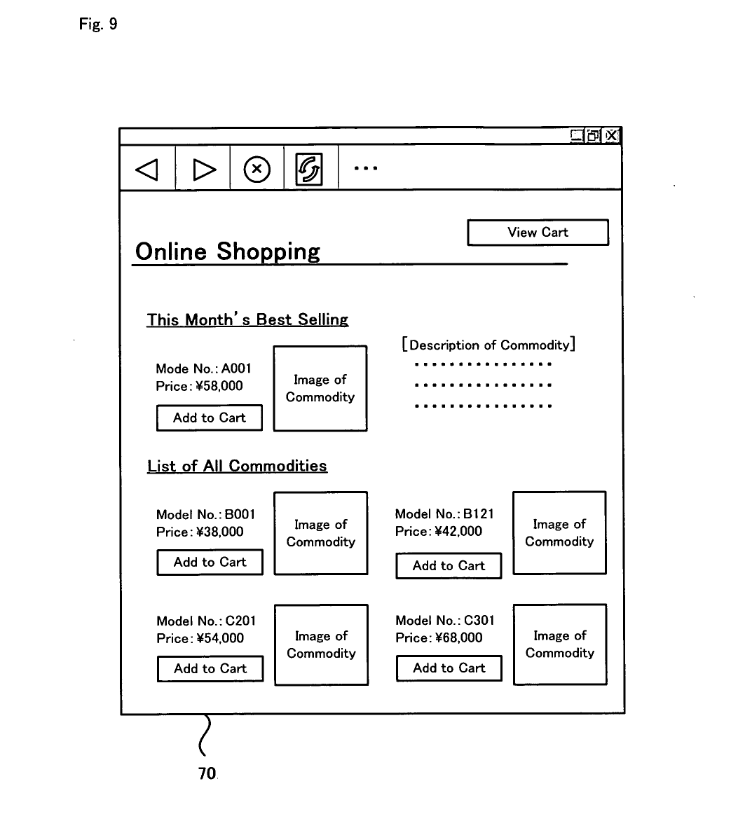

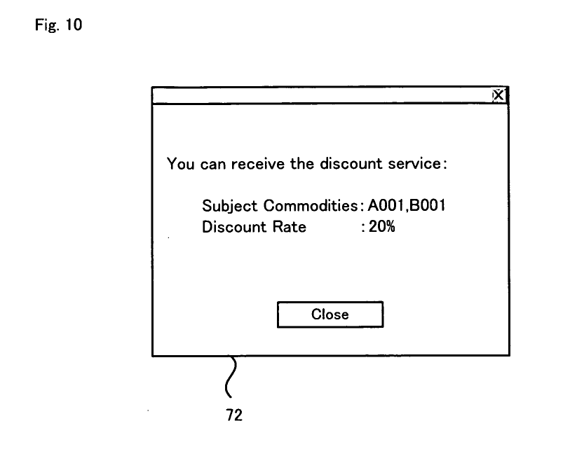

The description now regards the commodity trading process executed by the commodity trading management server 20 of the embodiment. The commodity trading process is executed when access request data for an access to a top page on a commodity trading site provided by the commodity trading management server 20 is sent from the client terminal 50. FIG. 8 is a flowchart showing a commodity trading routine. The commodity trading routine first executes a commodity data display step to send window data of a commodity display window 70 as a top page showing commodity-relating data to the client terminal 50 (step S200) . FIG. 9 shows one example of the commodity display window 70. In the illustrated example, the commodity display window 70 is designed to display information like model numbers and prices as the commodity-relating data. These pieces of information are read from the commodity table 29a in the database 29. The commodity data display step also reads and analyzes cookie files stored in the predetermined folder in the client terminal 50. When the discount service-relating data have been written in the cookie files and the current time is in the preset valid term of the discount service, the commodity data display step sends window data of a discount service information popup window 72 shown in FIG. 10 to the client terminal 50. In the illustrated example, the discount service information popup window 72 is designed to display information relating to the model numbers of subject commodities of the discount service and the discount rate written in the cookie files. The commodity data display step also writes information on selected commodities in an order in response to the user's click of an ‘Add to Cart’ button into cookie files in the client terminal 50. This process is common to the standard processing on a typical online shopping site and is not essential for the present invention, thus not being specifically described here.

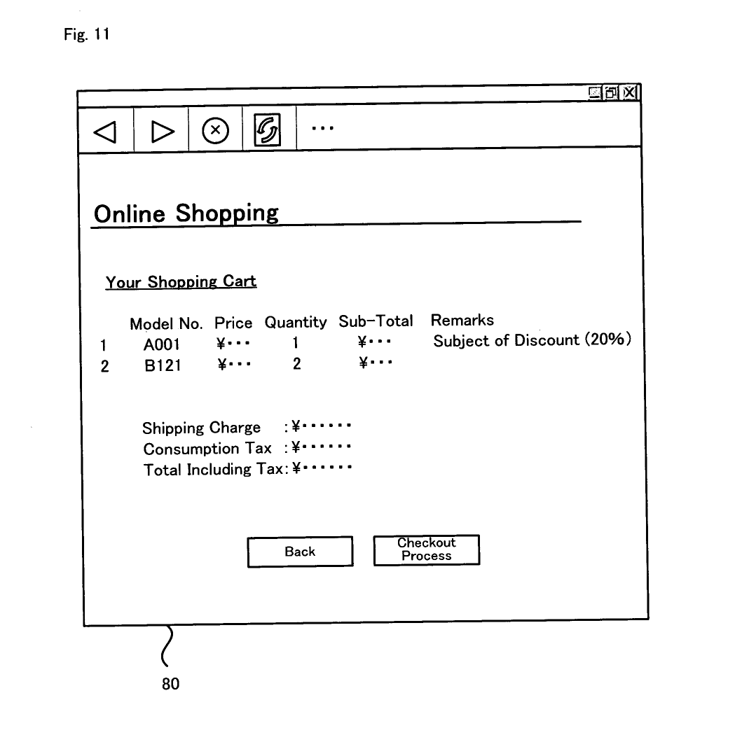

In response to the user's click of a ‘View Cart’ button on the commodity display window 70, the commodity trading routine executes an ordered commodity check step to send window data of an ordered commodity check window 80 that shows the information on the selected commodities in the order to the client terminal 50 (step S210) . FIG. 11 shows one example of the ordered commodity check window 80. In the illustrated example, the ordered commodity check window 80 is designed to display the information on the selected commodities in the order and a sum total including a shipping charge and a consumption tax. When the discount service-relating data have been written in the cookie files in the client terminal 50 and the current time is in the preset valid term of the discount service, the ordered commodity check step shows the discount price of each selected commodity, if set as a subject commodity of the discount service, and application of the discount service as remarks (subject of discount (20%) in the illustrated example of FIG. 11) based on the discount service-relating data, and calculates the sum total including the discount price. The information on the selected commodities in the order has been written into cookie files in the client terminal 50, as described previously. The information on the selected commodities in the order can thus be obtained by reading the cookie files.

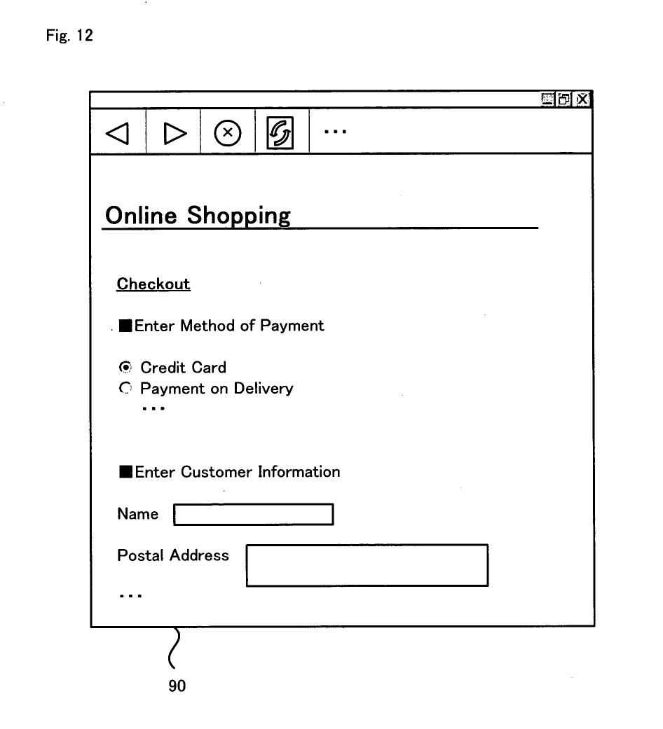

In response to the user's click of a ‘Checkout Process’ button on the ordered commodity check window 80, the commodity trading routine executes a checkout process step to send window data of a checkout process window 90 for the final purchase procedure to the client terminal 50 (step S220). The commodity trading routine is then terminated. FIG. 12 shows one example of the checkout process window 90. In the illustrated example, the checkout process window 90 is designed to ask the user to enter required pieces of information for the final purchase procedure including the method of payment and the user-relating information.

As described above, the commodity trading management server 20 of the embodiment determines whether the user of the client terminal 50 is an authorized user or an unauthorized user based on the user's entry on the user authentication window, in response to transmission of the request data of requiring execution of the discount service setting process from the client terminal 50. In the case of an authorized user, the commodity trading management server 20 retrieves the user class corresponding to the entered user ID in the user table 29b of the database 29, sets the discount service-relating data (including the commodity IDs allocated to the subject commodities of the discount service, the discount rate, and the valid term of the discount service) based on the retrieved user class, and write the settings of the discount service-relating data into cookie files in the client terminal 50. Namely different settings of the discount service-relating data are given to the respective user classes of the client terminals 50. In the commodity trading process, the commodity trading management server 20 provides the discount service, based on the settings of the discount service-relating data written in the cookie files in the client terminal 50. The concrete procedure outputs and displays the discount service information popup window 72 and applies the discount prices onto the ordered commodity check window 80. The commodity trading process can thus be executed according to the discount service-relating data written in the cookie files. This arrangement enables different settings of the discount service to be applied to the respective user classes without preparing multiple Web pages.

The portal site server 30 of the embodiment outputs and displays the top page 60 of the portal site including the banner ad 62. The banner ad 62 is used to publicize and advertise trading of commodities by the commodity trading management server 20 and is clicked to send the request data of requiring execution of the discount service setting process to the commodity trading management server 20. The top page 60 publicizes and advertises trading of commodities by the commodity trading management server 20 and encourages the user of the client terminal 50 to apply for the discount service.

The ROM 22, the RAM 23, and the HDD 24 included in the commodity trading management server 20 of the embodiment correspond to the data storage module of the invention. The NIC 25, the discount service data generation module 26, the discount service data transmission module 27, and the commodity trading process module 28 respectively correspond to the data reception transmission module, the service-providing data generation module, the service-providing data transmission module, and the trading process execution module of the invention. The ROM 32, the RAM 33, and the HDD 34 included in the portal site server 30 of the embodiment correspond to the data storage module of the invention. The portal site output module 36 corresponds to the electronic medium output module, and the top page 60 corresponds to the predetermined electronic medium.

In the structure of the embodiment discussed above, the commodity trading management server 20 outputs and displays the user authentication window to the client terminal 50 for the purpose of the user's authentication. The user's authentication may be omitted, when not required. In this case, the modified procedure may unconditionally set the discount service-relating data and write the settings of the discount service-relating data into cookie files in the client terminal 50, in response to transmission of the request data of requiring execution of the discount service setting process to the commodity trading management server 20. This procedure may send window data of a user ID entry window to the client terminal 50 and ask the user of the client terminal 50 to enter the user ID on the user ID entry window. The entered user ID is then used for retrieval of the user class in the user table 29a of the database 29.

The commodity trading management server 20 of the embodiment sets the discount service-relating data based on the value of the user class. Another method may be applied to set the discount service-relating data. One applicable procedure prepares multiple Web pages (for example, HTML files) for execution of the discount service setting process and specifies different settings of the discount service-relating data in the respective Web pages. Another applicable procedure uses fixed settings of the discount service-relating data.

In the commodity trading management server 20 of the embodiment, the discount service-relating data include the commodity IDs allocated to the subject commodities of the discount service, the discount rate, and the valid term of the discount service. Not all these data may be required, but the combination of only one or two of these data may be used instead. The discount service-relating data may include other pieces of data, in addition to or in place of part or all of these data.

In the commodity trading management server 20 of the embodiment, the user table 29b stores the information including the user ID, the user class, and the record of past transaction amounts. The user table 29b may store other pieces of information, in addition to or in place of part or all of these pieces of information. For example, the user table may store the number of execution of the discount service setting process. Execution or non-execution of the discount service setting process may be specified according to the number of execution. This arrangement restricts the number of writing the discount service-relating data into cookie files.

The commodity trading management server 20 of the embodiment sends the data for an access to the top page of the commodity trading site to the client terminal 50 in the end of the discount service setting process. Transmission of such data may be omitted, when not required.

The commodity trading management server 20 of the embodiment provides the user of the client terminal 50 with the discount service of selected commodities. The discount service may be replaced by another additional service relating to trading of commodities on the commodity trading site. One example is an exclusive merchandize-providing service to exclusively provide special commodities to specific users. In this example, data including commodity IDs allocated to exclusive commodities are set as the service-providing data and are written into cookie files in the client terminal 50. The commodity trading process reads out the commodity IDs written in the cookie files and displays information on the exclusive commodities, for example, on the commodity display window 70. Another example is an upgrade service to upgrade each selected commodity at the same price. When the commodity is a personal computer, the upgrade service offers, for example, change to an upgrade model, addition of an expansion memory, and extension of a maintenance service term. In this example, information on upgrade commodities is displayed on the ordered commodity check window 80.

The commodity trading management server 20 of the embodiment functions as the Web server. The Web technology is, however, not essential for this invention. The required technique is to process, receive, and send data in response to requests from the client device and thereby accomplish trading of commodities. The use of cookie files is also not essential, but any other technique may be used to store the discount service-relating data into the client device.

The commodity trading management server 20 of the embodiment is constructed as the general-purpose computer including the CPU 21, the ROM 22, and the RAM 23. The hardware configuration is, however, not restricted to this embodiment. The commodity trading management server 20 of the embodiment may be constructed by multiple general-purpose computers. For example, the computer executing the discount service setting process shown in the flowchart of FIG. 5 may be different from the computer executing the commodity trading process shown in the flowchart of FIG. 8.

In the structure of the above embodiment, the portal site server 30 causes the request data for requiring execution of the discount service setting process to be sent from the client terminal 50 to the commodity trading management server 20, in response to the user's click of the banner add 62 on the top page 60. The top page may be replaced with any equivalent electronic medium. For example, an e-mail including a statement or message equivalent to the banner ad 62 may be sent to the client terminal 50. In this case, the portal site server 30 functions as a mail server.

In the above embodiment, the technique of the present invention is applied to the commodity trading management server 20. The technique of the invention is also applicable to a corresponding commodity trading management method. Still another application is a program that causes one or multiple computers to function as the commodity trading management server 20 of the embodiment. In the case of such programs, the respective steps of the discount service setting routine shown in FIG. 5 and the commodity trading routine shown in FIG. 8 may be programmed in a suitable programming language.

The above embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

1. A commodity trading management device that manages information on trading of commodities with multiple client devices connected via a communication line, said commodity trading management device comprising:
a data storage module that stores at least commodity data relating to commodities;
a data reception transmission module that receives and transmits data from and to each of the multiple client devices;
a service-providing data generation module that causes said data reception transmission module to receive application data for a preset additional service relating to trading of a commodity sent from one of the multiple client devices and generates service-providing data required to receive the preset additional service based on the received application data;
a service-providing data transmission module that causes said data reception transmission module to send the generated service-providing data to the client device in a storable manner; and
a trading process execution module that, in the case of storage of the service-providing data in the client device that establishes connection with said commodity trading management device via the communication line, causes said data reception transmission module to receive the service-providing data from the client device and executes a commodity trading process for the preset additional service based on the received service-providing data and the commodity data stored in said data storage module, said trading process execution module executing a standard commodity trading process based on the commodity data stored in said data storage module in the case of no storage of the service-providing data in the client device.

2. A commodity trading management device in accordance with clam 1, said commodity trading management device functioning as a Web server,
wherein said service-providing data transmission module sends the service-providing data as data of at least part of cookie files stored in the client device.

3. A commodity trading management device in accordance with claim 1, wherein said service-providing data generation module regards access request data for an access to a preset resource sent from the client device as the application data and generates the service-providing data based on the access request data regarded as the application data.

4. A commodity trading management device in accordance with claim 1, wherein said service-providing data generation module executes a predetermined user authentication process to determine whether a user of the client device that has sent the application data is an authorized user or an unauthorized user, and generates the service-providing data when it is determined that the user of the client device is an authorized user.

5. A commodity trading management device in accordance with claim 1, wherein said data storage module stores at least user identification information on identification of each user and user class information regarding a class of the user, as user-relating information,
the application data include user identification information on a user of the client device that has sent the application data, and
said service-providing data generation module reads the user identification information of the application data, retrieves the user class information corresponding to the user identification information stored in said data storage module, and generates the service-providing data based on the retrieved user class information.

6. A commodity trading management device in accordance with claim 1, wherein said data storage module stores at least user identification information on identification of each user and a data generation frequency, which represents a frequency of generation of the service-providing data with regard to the user, as user-relating information,
the application data include user identification information on a user of the client device that has sent the application data, and
said service-providing data generation module reads the user identification information of the application data, retrieves the data generation frequency corresponding to the user identification information stored in said data storage module, and generates the service-providing data and updates the data generation frequency stored in said data storage module when the retrieved data generation frequency is within a present number of times.

7. A commodity trading management device in accordance with claim 1, wherein said service-providing data transmission module sends the service-providing data to the client device, while sending instruction data for connection to said commodity trading management device to the client device.

8. A commodity trading management device in accordance with claim 1, wherein the service-providing data include at least a valid term of the preset additional service, and
said trading process execution module determines, in the case of storage of the service-providing data in the client device, whether a current time is within the valid term based on the valid term of the service-providing data, and executes the commodity trading process for the preset additional service in the case of determination that the current time is within the valid term, while executing the standard commodity trading process in the case of determination that the current time is out of the valid term.

9. A commodity trading management device in accordance with claim 1, wherein the preset additional service is a discount service of a commodity,
the commodity data include at least a standard price of the commodity, and
the commodity trading process for the preset additional service makes a discount on the standard price of the commodity.

10. A commodity trading management device in accordance with claim 9, wherein the service-providing data include subject commodity identification information on identification of a subject commodity of the discount service, and
the commodity trading process for the preset additional service makes a discount on the standard price of the subject commodity specified by the subject commodity identification information.

11. A commodity trading management device in accordance with claim 9, wherein the service-providing data include discount rate information on a discount rate of the discount service, and
the commodity trading process for the preset additional service makes a discount on the standard price of the commodity according to the discount rate information.

12. A commodity trading management device in accordance with claim 1, wherein the preset additional service is a
commodity upgrade service, and the commodity trading process for the preset additional service upgrades the commodity at an identical price.

13. A commodity trading management device in accordance with claim 1, wherein the preset additional service is an exclusive commodity providing service,
the commodity data include at least exclusive commodity class information on a class of exclusive commodity, and
the commodity trading process for the preset additional service enables trading of an exclusive commodity specified by the exclusive commodity class information.

14. A commodity trading management device in accordance with claim 13, wherein the service-providing data include subject commodity identification information on identification of a subject commodity of the exclusive commodity providing service, and
the commodity trading process for the preset additional service enables trading of an exclusive commodity specified by the subject commodity identification information.

15. A storage medium in which a commodity trading management device program is stored, said commodity trading management device program causing a computer, which comprises a data storage module that stores at least commodity data relating to commodities and a data reception transmission module that receives and transmits data from and to each of multiple client devices, to function as a commodity trading management device that manages information on trading of commodities with the multiple client devices connected via a communication line,
said commodity trading management device program stored in said storage medium comprising:
a service-providing data generation module that causes said data reception transmission module to receive application data for a preset additional service relating to trading of a commodity sent from one of the multiple client devices and generates service-providing data required to receive the preset additional service based on the received application data;
a service-providing data transmission module that causes said data reception transmission module to send the generated service-providing data to the client device in a storable manner; and
a trading process execution module that, in the case of storage of the service-providing data in the client device that establishes connection with said commodity trading management device via the communication line, causes said data reception transmission module to receive the service-providing data from the client device and executes a commodity trading process for the preset additional service based on the received service-providing data and the commodity data stored in said data storage module, said trading process execution module executing a standard commodity trading process based on the commodity data stored in said data storage module in the case of no storage of the service-providing data in the client device.

16. A service-providing data generation device that generates service-providing data required to receive a preset additional service relating to trading of commodities with multiple client devices connected via a communication line, said service-providing data generation device comprising:
a data reception transmission module that receives and transmits data from and to each of the multiple client devices;
a service-providing data generation module that causes said data reception transmission module to receive application data for the preset additional service relating to trading of a commodity sent from one of the multiple client devices and generates the service-providing data based on the received application data; and
a service-providing data transmission module that causes said data reception transmission module to send the generated service-providing data to the client device in a storable manner.

17. A service-providing data generation device in accordance with claim 16, said service-providing data generation device functioning as a Web server,
wherein said service-providing data transmission module sends the service-providing data as data of at least part of cookie files stored in the client device.

18. A commodity trading publicity device that publicizes trading of commodities by a commodity trading management device, said commodity trading management device receiving application data for a preset additional service relating to trading of a commodity sent from one of multiple client devices connected via a communication line, generating service-providing data required to receive the preset additional service based on the received application data, sending the generated service-providing data to the client device, and executing, in the case of storage of the service-providing data in the client device that establishes connection with said commodity trading management device via the communication line, a commodity trading process for the preset additional service based on the service-providing data, while executing a standard commodity trading process in the case of no storage of the service-providing data in the client device,
said commodity trading publicity device comprising:
a data storage module that has a transmission instruction area to instruct the client device to send the application data to said commodity trading management device and stores data regarding a predetermined electronic medium to publicize trading of commodities by said commodity trading management device; and
an electronic medium output module that outputs the predetermined electronic medium to the client device, based on the data regarding the predetermined electronic medium stored in said data storage module.

19. A commodity trading publicity device in accordance with claim 18, wherein the predetermined electronic medium is either of a Web page and an e-mail, and
the transmission instruction area represents an area of instructing the client device to send the application data by means of a hyperlink function.

20. A commodity trading management system that comprises a commodity trading management device that manages information on trading of commodities with multiple client devices connected via a communication line and a commodity trading publicity device that publicizes trading of commodities by said commodity trading management device,
said commodity trading management device comprising: a data storage module that stores at least commodity data relating to commodities; a data reception transmission module that receives and transmits data from and to each of the multiple client devices; a service-providing data generation module that causes said data reception transmission module to receive application data for a preset additional service relating to trading of a commodity sent from one of the multiple client devices and generates service-providing data required to receive the preset additional service based on the received application data; a service-providing data transmission module that causes said data reception transmission module to send the generated service-providing data to the client device in a storable manner; and a trading process execution module that, in the case of storage of the service-providing data in the client device that establishes connection with said commodity trading management device via the communication line, causes said data reception transmission module to receive the service-providing data from the client device and executes a commodity trading process for the preset additional service based on the received service-providing data and the commodity data stored in said data storage module, said trading process execution module executing a standard commodity trading process based on the commodity data stored in said data storage module in the case of no storage of the service-providing data in the client device,
said commodity trading publicity device comprising: a data storage module that has a transmission instruction area to instruct the client device to send the application data to said commodity trading management device and stores data regarding a predetermined electronic medium to publicize trading of commodities by said commodity trading management device; and an electronic medium output module that outputs the predetermined electronic medium to the client device, based on the data regarding the predetermined electronic medium stored in said data storage module.
